(19) United States
(12) Patent Application Publication
(10) Pub. No.: US 2004/0158033 A1
(43) Pub. Date: Aug. 12, 2004

(54) Treated lignosulfonates as additives for cementitous systems

(76) Inventors: Robert A.C. Benson, North Bay (CA); David Robert Cameron, Temiscaming (CA); Jeffrey Gordon Sharman, Sherbrooke (CA); Juraj Strmen, Tee Lake (CA); Carmel R. Jolicoeur, Deauville (CA)

Correspondence Address: Santosh K. Chari, McCarthy Tetrault LLP, 66 Wellington St. W, Suite 4700, P.O. Box 48, Toronto, ON, M5K 1H6, CA

(21) Appl. No.: 10/359,074

(22) Filed: Feb. 6, 2003

(51) Int. Cl. C08L 97/00

(52) U.S. Cl. 530/200

(57) ABSTRACT

A process for preparing a lignosulfonate additive for use as a dispersant in cement or concrete compositions comprises treating a lignosulfonate solution with salts of trivalent metals. Preferably, such salts comprise nitrates or sulphates of aluminum, iron, copper, or manganese.

### BACKGROUND OF THE INVENTION

1. Field of the Invention

The present invention relates to treated lignosulfonate additives for cement compositions for reducing the quantity of entrained air in the cement paste, mortar or concrete and maintaining the desired strength characteristics.

2. Description of the Prior Art

Cement, or Portland cement, is a common material that is used for a variety of purposes. In one use, cement powder is combined with sand and water to form mortar or is combined with water, sand and gravel to form concrete. It is known that one of the main factors that determines the strength characteristics of cementitious systems, once set, is the water to cement ratio in the initial composition. Although water is needed in order to provide a workable mixture, excess water leads to decreased strength of the mortar or concrete. For this reason, various water-reducing additives have been proposed to increase the fluidity of the cement paste or mortar or concrete mixture while requiring less water. Such additives are often referred to as water-reducing agents. Lignosulfonates, which are by-products of wood pulp mills, are common water-reducing agents known in the art. For example, it has been found that addition of lignosulfonates in concrete mixtures can reduce the water demand for a given workability or fluidity by up to 10 to 15%.

While providing the desired water reduction, lignosulfonate addition has also been found to increase the quantity of entrained air of concrete mixtures. Although in some cases, a small quantity of entrained air is desirable to offset freeze/thaw problems, a higher amount of entrained air, whether in the form of a higher density of air bubbles or large air bubbles, severely reduces the compressive strength of the concrete. Generally, the desired air content in concrete is approximately 2 to 4% by volume. However, with certain lignosulfonate additions, air content and has been found to rise to 6 to 8% by volume or more.

To counteract the air entrainment effects due to lignosulfonates, it is common to add other additives such as surfactants or defoamers etc., which results in increased cost and process requirements. For example, U.S. Pat. Nos. 3,960,582 and 4,019,918 teach additives for producing a low porosity cement having extended set times. As an alternative to adding further components, U.S. Pat. No. 6,238,475 teaches a method of chemically treating the lignosulfonate component itself to reduce air entrainment. In each case, the addition or treatment steps still involve higher process costs.

Therefore, there exists a need for a treatment process for lignosulfonates that reduces air entrainment when mixed with cementitious systems such as cement pastes, mortar or concrete compositions.

### SUMMARY OF THE INVENTION

In one embodiment, the present invention provides a process for treating lignosulfonates to provide dispersants for cementitious compositions comprising:

providing a lignosulfonate solution; and,

treating said solution with trivalent metal salts.

In another embodiment, the invention provides a process for preparing a lignosulfonate additive for cement or concrete fluidization, the process comprising:

providing a lignosulfonate solution;

treating said lignosulfonate solution with aluminum or iron salts in an amount between 0.05% and 4% aluminum or iron based on the dry weight of the lignosulfonate;

wherein said treatment is conducted at a temperature between 4° C. and 125° C. and at a pH between 3.5 and 8.

In yet another embodiment, the invention provides an additive for fluidizing and reducing air entrainment of cement or concrete mixtures comprising a lignosulfonate solution treated with salts of trivalent metals.

### BRIEF DESCRIPTION OF THE DRAWINGS

These and other features of the preferred embodiments of the invention will become more apparent in the following detailed description in which reference is made to the appended drawings wherein:

FIG. 1 is a graph illustrating the air entrainment effect of adding lignosulfonate to cement as discussed in Example 2.

FIG. 2 is a graph illustrating the results of Example 4, showing the reduction in air entrainment resulting from the treated lignosulfonates of the present invention.

FIG. 3 is a graph illustrating the results of Example 5.

FIGS. 4 to 6 are graphs illustrating the results of the air entrainment tests of Example 6, showing the effect in varying the Al concentration in the treatment composition.

FIG. 7 is a graph illustrating the effect of reaction temperature on air entrainment in cement paste as discussed in Example 7.

FIG. 8 is a graph illustrating the results of Example 8, showing the effects of varying Al concentration on air entrainment.

FIGS. 9a to 9i are graphs illustrating the results of Example 10, showing the effects of several variables on air entrainment.

FIG. 10 is a graph illustrating the results of Example 11, showing the air reducing effects of Al derived from Al(NO₃)₃.

FIG. 11 is a graph illustrating the results of Example 11, comparing the air reducing effects of Al derived from Al(NO₃)₃ and Al₂(SO₄)₃.

FIG. 12 is a graph illustrating the results of Example 12, wherein the lignosulfonate treatment is conducted with Fe.

FIG. 13 is a graph illustrating the results of Example 13, comparing the effects on lignosulfonates of Al or Fe treatment.

FIG. 14 is a graph illustrating the results of Example 14, showing the effects of various lignosulfonate treatment criteria on air entrainment.

FIG. 15 is a graph illustrating the results of Example 15, showing the effect of varying Al % on air entrainment.

### DESCRIPTION OF THE PREFERRED EMBODIMENTS

As further described below, the present invention provides lignosulfonates that are treated with aluminum (Al) or iron (Fe) salts. Such treatment has been found to significantly reduce the air entrainment effects of lignosulfonates when mixed in cementitious systems including cement pastes, mortar or concrete to the desired values indicated above. For brevity, the following description will refer to cementitious systems; however, it will be understood that this term is meant to include cement pastes, mortar, and concrete and other such compositions as well.

Lignosulfonates used in the present invention can be obtained from any known source. As indicated above, lignosulfonates are generally obtained from the wood or pulp industry as a waste product. For the present invention, the lignosulfonates can be obtained from either hardwoods or soft woods as Ca, Mg, Na or ammonium salts. Ammonium lignosulfonates may be converted to sodium or calcium salts and either form can be used with the present invention. According to the present invention, Al or Fe salts are added to a lignosulfonate solution and allowed to contact for a period of time and at a temperature as will be discussed. In a preferred embodiment, the Al or Fe salts are added to a lignosulfonate stream resulting directly from the pulping process. Alternatively, the Al or Fe treatment can be carried out separately from a pulping operation.

It is believed that one reason for increased air entrainment in cement resulting from lignosulfonate addition lies with the presence of fatty acid and/or resin acid components in the lignosulfonate composition. Although the mechanism of the Al or Fe treatment of lignosulfonates is not fully understood, it is believed that the addition of such salts forms colloids with the fatty acid components, thereby reducing their air entrainment effect. This putative effect is not intended to limit the invention in any way and is merely offered as a possible explanation.

As discussed below, the present invention has been found to be effective with either Al or Fe treatment. As illustrated in the following examples, Al concentrations that are usable in lignosulfonate compositions of the present invention range from 0.1% to 4% (w/w). Although no maximum value was observed, the degree of improvement between 1% and 4% was found to be close to the maximum achievable. For this reason it is believed that an Al concentration greater than 4%, although usable, will not provide any further benefit.

The Al and Fe treatment components of the invention can be added in the form of a variety of Al and Fe salts. For example, as illustrated below, Al salts can include alum or aluminum sulphate (Al₂(SO₄)₃) and aluminum nitrate, Al(NO₃)₃. The Fe salts can include FeSO₄ (i.e. Fe II salts) and Fe₂(SO₄)₃ (i.e. Fe III salts). Chlorides salts of iron or aluminum may also be used. Due to its availability, Al₂(SO₄)₃ is the preferred salt for the present invention.

The method of the present invention can be applied to lignosulfonates at a variety of temperatures ranging from 4° C. to 125° C. It was found that improved results are obtained at higher temperatures such as 98° C. or higher. This offers a further advantage since, in the preferred case, the treatment is carried out on the lignosulfonate stream produced during the pulping process, which is generally at a temperature greater than 100° C. As such, no additional cost need be expended for achieving the desired reaction temperature. Although higher temperatures (i.e. close to 100° C.) are preferred, temperatures above the boiling point of the solution were found to result in undesirable foam formation. Therefore, the most preferred treatment, or reaction, temperature would be 80° C. to 105° C., i.e. below the boiling point of the lignosulfonate solution.

The process of the invention can also be carried out at various pH levels ranging from 2 to 8. In addition, the mixing times for the reaction between the lignosulfonates and the Al or Fe salts can be greater than a few minutes.

As described further below, the temperature, time, and pH of the lignosulfonate treatment do have some effect on air entrainment reduction. However, various preferred conditions have been identified based on commercial needs.

In the present invention, a reaction pH of between 4 and 8 was found to be acceptable. A pH of about 6 is preferred.

As will be seen in the following examples, the preferred embodiment of the invention involves the reaction of a 50% sodium lignosulfonate composition with 0.1 to 4%, and preferably, 0.25% (w/w) Al, added in the form of alum, at a temperature of 80° C. for 2 hours and at a pH of about 6.

### EXAMPLES

The following examples are provided solely to illustrate the present invention and are not meant to limit the invention in any way.

### Example 1

### Measurement of Air Entrainment

The following is a brief description of the protocol used to measure air entrainment and fluidity of cement pastes throughout this study. The air entrainment calculation was based on density measurements of the cement while the fluidity was measured using a “mini-slump” spread method. The following components were used for both air and fluidity measurements:

400 g cement e.g. St-Lawrence Type 10 cement

204 g water (distilled or tap water) for W/C (water/cement ratio) of 0.51

1.8 g dry lignosulfonate for 0.45% LS on cement.

Since the lignosulfonate is normally treated, or dosed, in liquid form, the mass of water contained in the sample is subtracted from the mass of water, i.e. for 50% solution 3.6 g LS (lignosulfonate) and 202.2 g water can be used.

Lignosulfonate and water are weighed into a beaker. A metal container approximately 6.5″ high, 3¾″ top diameter, and 2¼″ bottom diameter was used. Cement is weighed into a 400 ml beaker.

Mixing:

As cement is added into water or the water and lignosulfonate mixture, a chronometer is started. The mixture is mixed by hand for 1 minute using a small lab spoon and subsequently mixed for 2 minutes with a Braun hand held kitchen mixer (200 watt model).

Air Entrainment Measurement:

45 seconds before the measuring time, the paste is mixed with the flat end of lab spoon for 15 seconds. The beaker is tared on the balance. The paste is poured into the weighing beaker: a Plexiglas cylinder approx. 4.1″ in height and approx. 2″ in diameter (the volume of which is approx. 200 to 210 ml). At the measuring time, the paste is levelled flush with the top of the beaker and weighed. This provides both the weight and volume of the mixture with which, the density can be calculated. Following this, the amount of air in the mixture can be determined with the following relationship:

$$\begin{matrix}\% Air = \frac{{mass}_{th} - mass}{{mass}_{th}} \\ {mass}_{th} = \frac{{M}_{c} + {M}_{w}}{[ \frac{Mc}{ρ c} ] + {M}_{w}} \times {V}_{b}\end{matrix}$$

Where: M_{c} is the mass of cement, M_{w} is the mass of water, ρ_{c} is the density of cement and V_{b} is the volume of the container. The density of the cement is 3.15. The volume of the container is 205.5 ml.

The air measurements are taken at 6, 36 and 66 minutes after water/cement contact.

### Example 2

### Air Entrainment Effects of Lignosulfonate Addition in Cement Paste

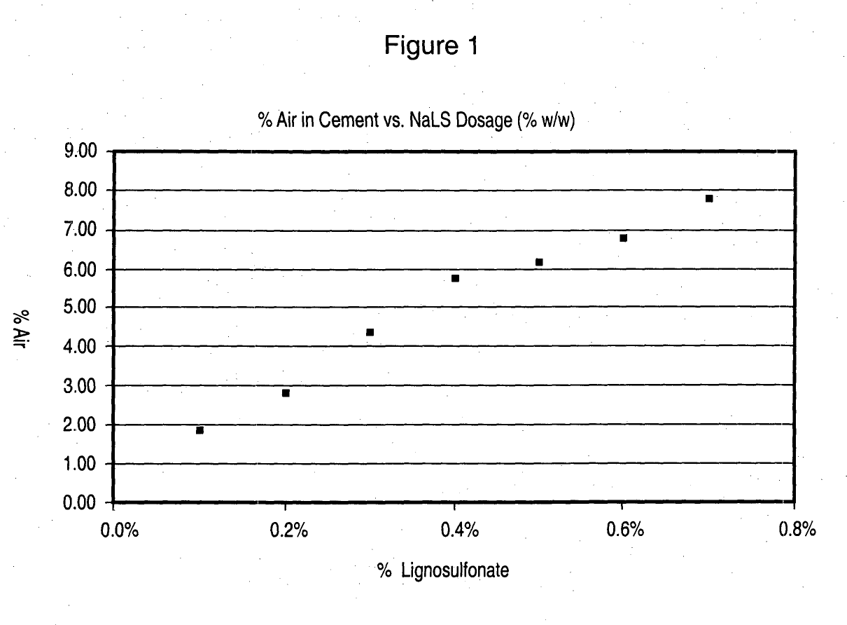

In this example, various concentrations of a lignosulfonate solution were added to cement paste in order to measure the air entrainment effects. As illustrated in FIG. 1, there is a high correlation between the amount of lignosulfonate added and the amount of air entrained in the cement paste.

### Example 3

### Air Entrainment Effects of Treated Lignosulfonate Addition in Cement Paste

In the following tests, samples of cement paste were mixed with sodium lignosulfonate with or without treatment with aluminum sulphate. A dosage of 0.45% sodium lignosulfonate was applied to a cement paste slurry with a water cement ratio of 0.51 w/w. The treatment method consisted of reacting a 50% sodium lignosulfonate solution with 0.5% aluminum (in a solution of alum at 48% concentration) at a temperature of 80° C. for 2 hours. Three cement paste samples (I, II, and III) were tested with the treated and untreated lignosulfonate (LS). The results from these tests are summarized in Table 1 below.

TABLE 1

| | % Air in Cement Paste | | |
|---|---|---|---|
| | Time After Mixing (minutes) | | |
| Sample | 6 | 36 | 66 |
| I- untreated LS | 6.08 | 4.54 | 4.30 |
| I - treated LS | 4.93 | 3.16 | 2.85 |
| II - untreated LS | 7.24 | 5.77 | 4.74 |
| II - treated LS | 4.27 | 3.05 | 2.84 |
| III - untreated LS | 7.53 | 6.52 | 5.65 |
| III - treated LS | 4.44 | 3.41 | 2.91 |

As can be seen, the use of treated lignosulfonate resulted in reduced air entrainment in all cement paste samples.

Following the above tests, lignosulfonates were evaluated in concrete with a dosage of 0.25% sodium lignosulfonate in cement and a water/cement ratio of 0.5. The results from the concrete tests are summarized in Table 2 below.

TABLE 2

| | % Air in |
|---|---|
| Sample | Concrete |
| I - untreated LS | 10.0 |
| I - treated LS | 6.5 |
| II - untreated LS | 15.0 |
| II - treated LS | 8.0 |
| III - untreated LS | 12.5 |
| III - treated LS | 7.5 |

As can be seen from the above, the air entrainment in cement paste samples was reduced by 20% to 45% when the treated lignosulfonates of the present invention were used. Similarly, the air entrainment in concrete was reduced by 35% to 50%.

### Example 4

### Treated Lignosulfonates in Cement Pastes

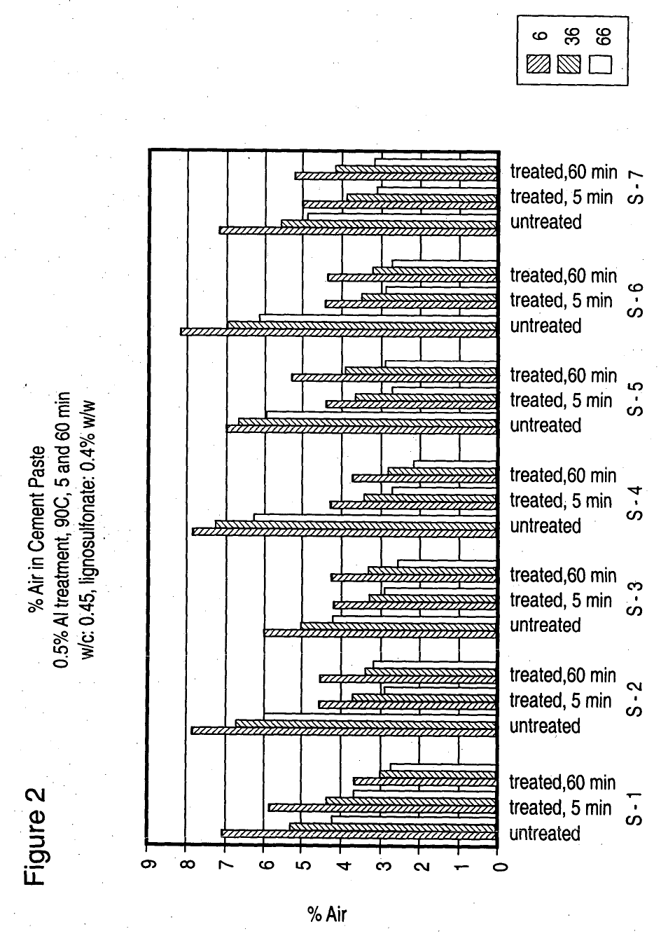

Seven samples (S-1 to S-7) of lignosulfonates (LS) were treated with 0.5% dry wt/wt of aluminum (in the form of alum). The seven samples were heated to 90° C., the alum was added, hot water was added to dilute the sample to 48% solids, and the samples were heated for 5 minutes or 60 minutes. No pH adjustment was performed. The % air in cement paste for these samples are illustrated in FIG. 2. As with the above example, air content measurements were taken after 6, 36 and 66 minutes of mixing the cement with the LS.

As can be seen, on average, by treating the LS with 0.5% alum for 6, 36 and 66 minutes, the entrained air in cement paste can be reduced by 39%, 45% and 47%, respectively.

### Example 5

### Further Tests of Air Entrainment Reduction of Treated Lignosulfonates

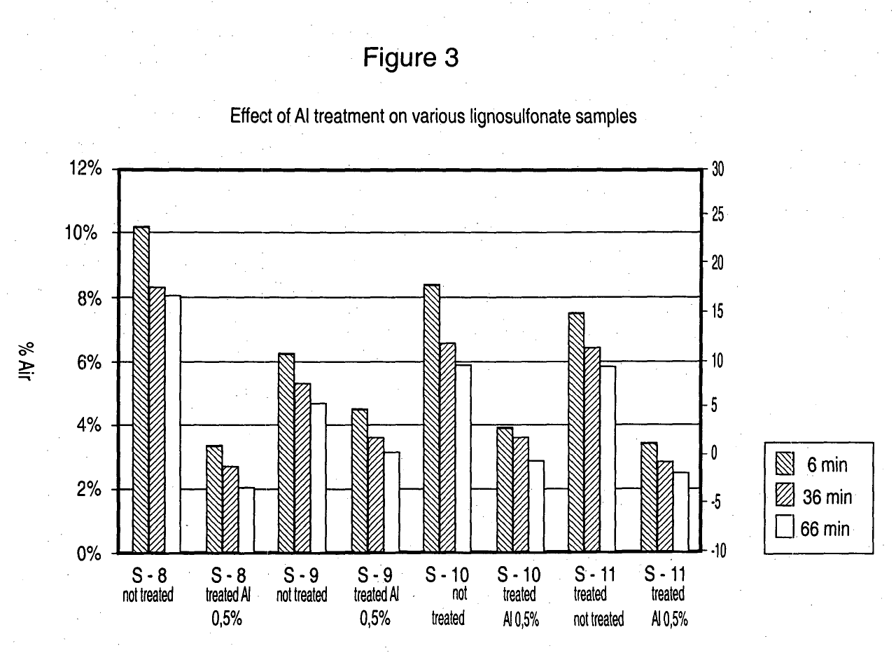

FIG. 3 illustrates the results of air entrainment measurements of other cement paste compositions comparing lignosulfonate (LS) additions both with and without treatment with Al. In this case, four samples (S-8 to S-11) were tested. The LS samples were treated with 0.5% Al As with the previous results, a significant reduction in air entrainment is achieved with using the treated LS. According to FIG. 3 there was a decrease in % air content for treated samples compared to control (untreated) lignosulfonate samples. For example, in sample S8, the % air was reduced from 8% to 2%.

### Example 6

### Tests of Air Entrainment Reduction of Treated Lignosulfonates with Varying Al Concentrations

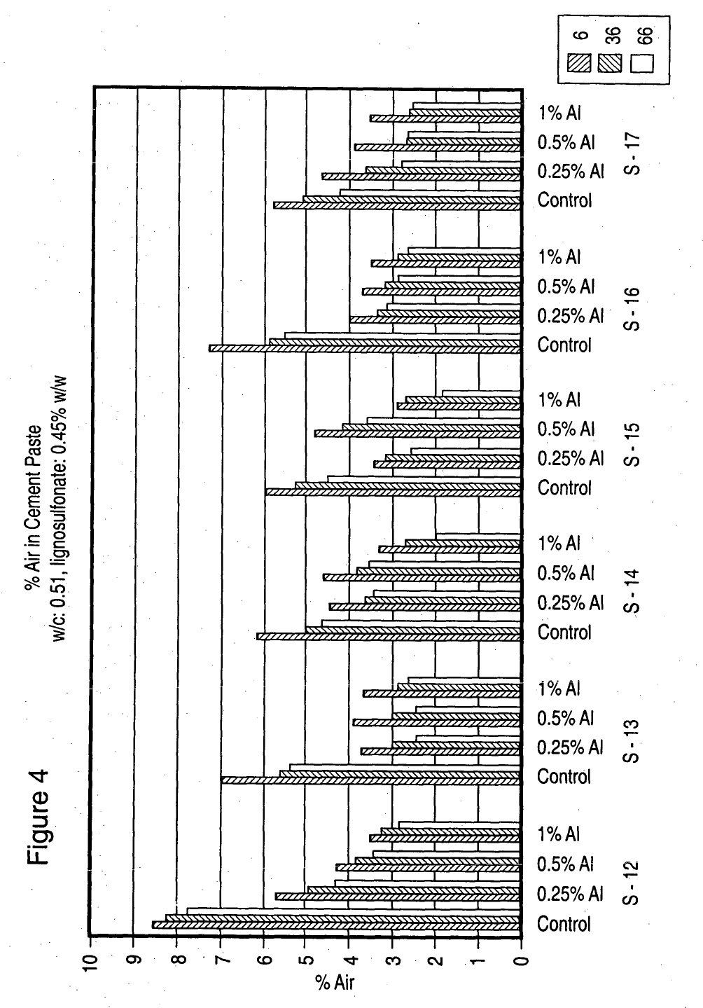

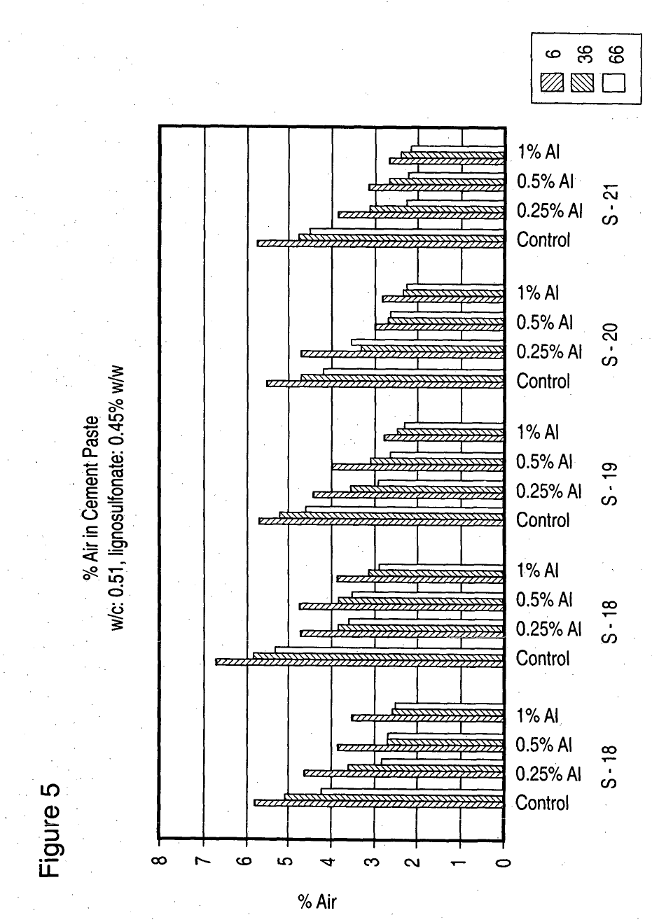

FIGS. 4 and 5 illustrate further test results (S-12 to S-21) indicating the air entrainment reduction characteristics of the present invention. In addition, FIGS. 4 and 5 also illustrate the results of Al treatment compositions where the Al concentration is 0.25%, 0.5% and 1%. In these tests, the water to cement ratio was 0.51 and the lignosulfonate dosage was 0.45% w/w based on weight of cement.

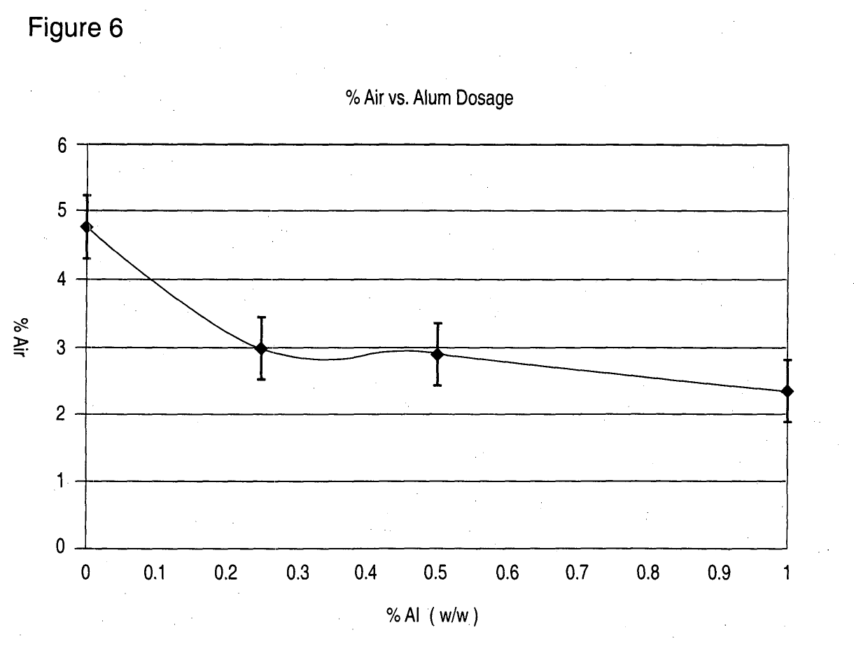

As can be seen in FIGS. 4 and 5, increasing Al concentrations result in decreased air entrainment. However, the incremental advantage is reduced as the Al concentration is increased. This is further discussed below with respect to FIG. 6.

FIG. 6 illustrates the average results of tests of nine samples wherein the air entrainment value is plotted against the Al concentration. As can be seen, the effect of Al concentration is found to level off after about 0.25%. On this basis, it is expected that the further decrease in air entrainment achieved by higher Al concentrations will not be significant.

### Example 7

### Varying Reaction Temperature of Lignosulfonate Treatment

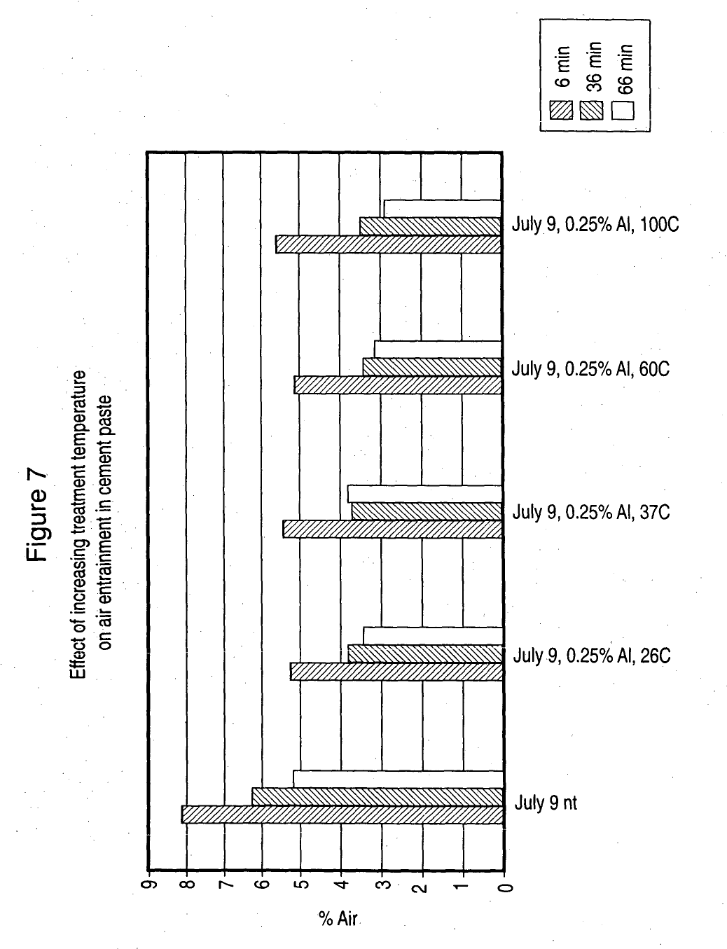

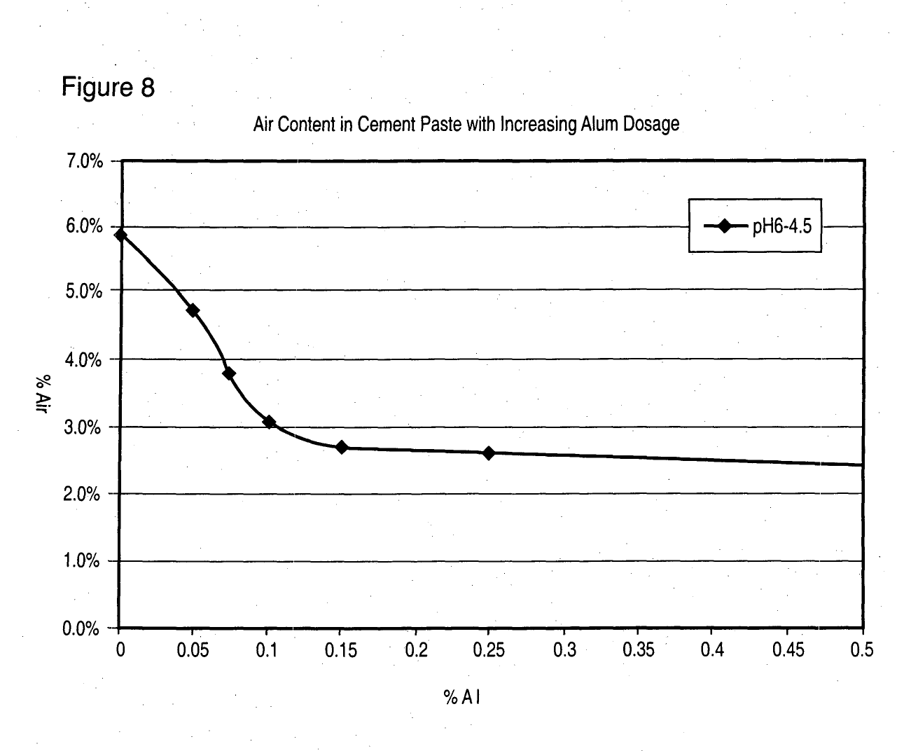

FIG. 7 illustrates the effect of the reaction temperature during the lignosulfonate treatment. In this example, various reaction temperatures were tested, namely, 26° C., 37° C., 60° C., and 100° C. As can be seen, and as discussed further below in reference to Example 10, the reaction temperature during lignosulfonate treatment did not have much of an effect on the air entrainment effects of the treated material. Although a slight improvement in air entrainment reduction was found when the reaction temperature is increased, the amount of such improvement was minimal and would not warrant the extra cost of heating the treatment solution.

### Example 8

### Varying Al Concentration of Lignosulfonate Treatment

In this example, a lignosulfonate solution was treated with varying concentrations of Al ranging from 0 to 0.5%. The treatment was conducted at 80° C. for 20 minutes at a start pH of 6 and a final pH of 4. It was found that increasing the concentration of Al beyond about 0.25% w/w did not improve air entrainment characteristics, which is similar to the results of example 6.

### Example 9

### Effect of Mixing Time on Al Treatment of Lignosulfonates

The issue addressed in this series of tests was whether there was any difference in: a) combining the LS+Alum and mixing for 5 minutes and left sitting for 90 minutes; or b) mixing the composition for 90 minutes. Based on the results of these tests, it was determined that mixing for 5 minutes was sufficient. Mixing for 90 minutes was found to reduce the air entrainment effects by 52% (as compared to a cement composition with untreated LS added) whereas mixing for 5 minutes was found to reduce this value by 45%. Therefore, the marginal improvement in increasing the mixing time may not be warranted.

### Example 10

### Effect of Varying Multiple Treatment Variables

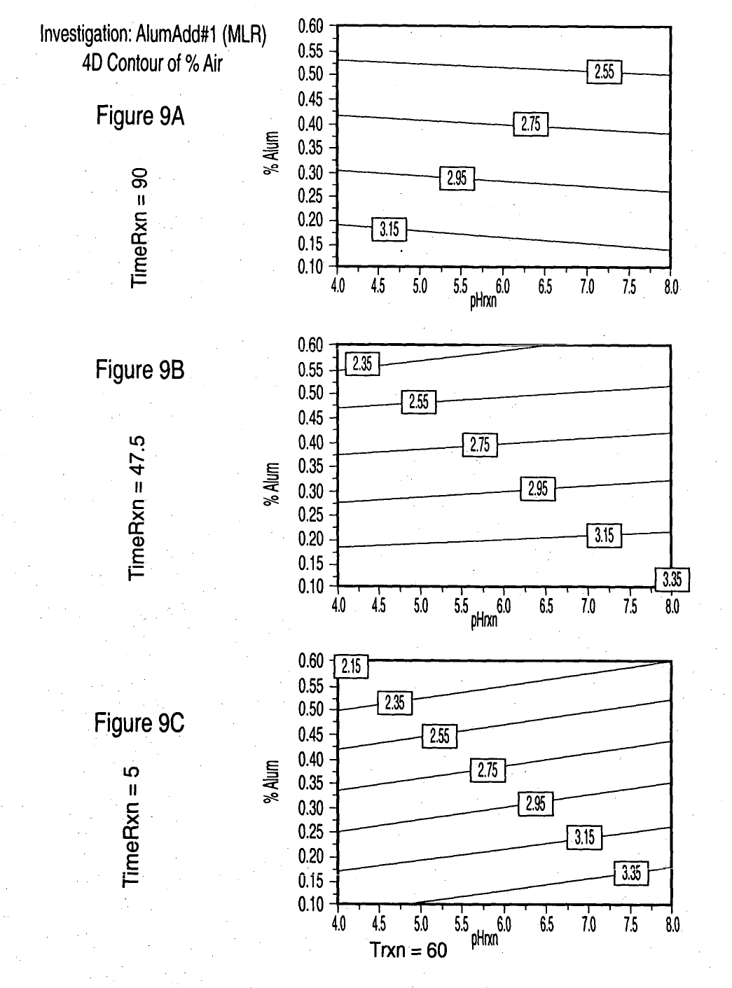

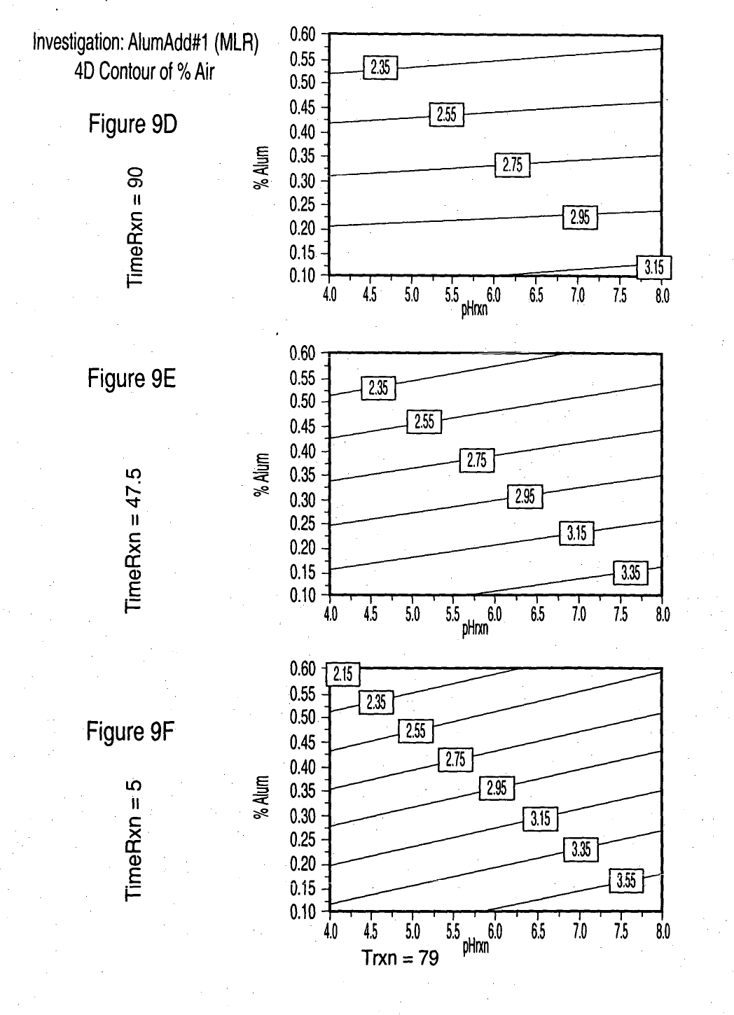

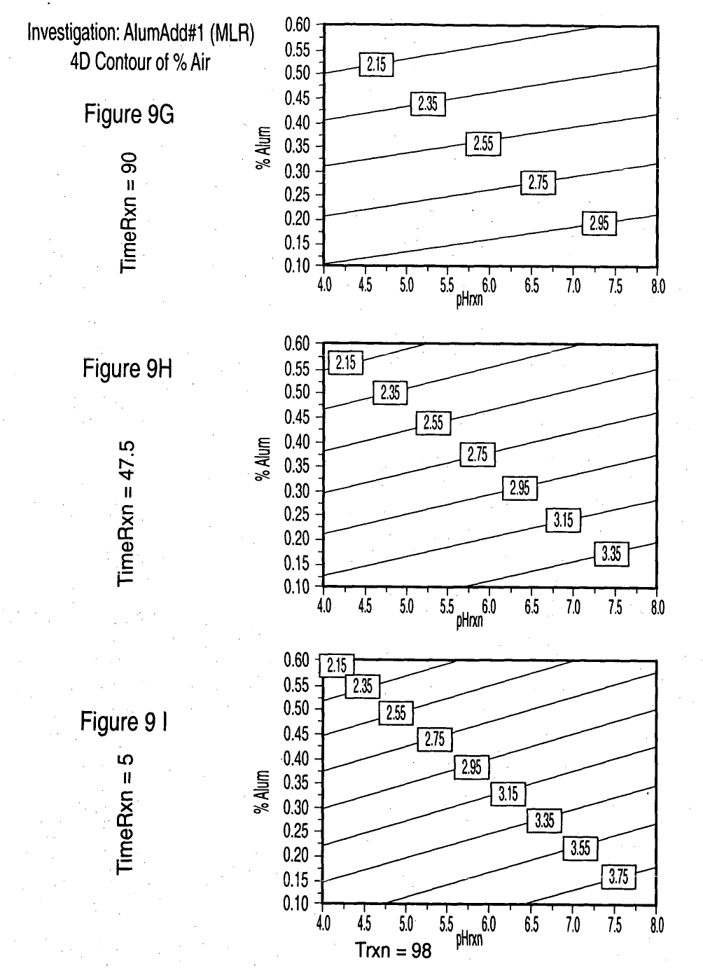

In these tests, the effect on air entrainment of treated lignosulfonates (LS) was investigated based on the following variables: a) adjusting Al concentration from 0.1% to 0.6% (w/w); b) adjusting pH from 4.4 to 8; c) adjusting reaction time (i.e. the time of treating the LS samples with Al) from 5 minutes to 90 minutes; and d) adjusting the reaction temperature from 60° C. to 98° C. Aluminum was added in the form of alum (aluminum sulphate) and was added cold to a hot LS liquor solution. The pH of the LS liquor was adjusted before addition of the alum by addition of H₂SO₄. FIGS. 9a to 9i illustrate the results of the various tests of this example, wherein: “Trxn” refers to the reaction temperature (in ° C.); “TimeRxn” refers to the reaction time; and “pHrxn” refers to the pH of the reaction between LS and Al. For each graph, the contour lines represent the air content (as % air) in the cement paste.

Table 3 below summarizes the data on which FIG. 9 is based.

TABLE 3

| | | | Trxn | TimeRxn | |
|---|---|---|---|---|---|
| Expt. # | pHrxn | % Al | (° C.) | (min) | % Air |
| 1 | 4.44 | 0.1 | 60 | 5 | 3.48 |
| 2 | 7.68 | 0.1 | 60 | 5 | 3.36 |
| 3 | 4.55 | 0.6 | 60 | 5 | 2.00 |
| 4 | 6.22 | 0.6 | 60 | 5 | 2.53 |
| 5 | 4.53 | 0.1 | 105 | 5 | 3.33 |
| 6 | 8.26 | 0.1 | 105 | 5 | 3.62 |
| 7 | 4.51 | 0.6 | 105 | 5 | 2.44 |
| 8 | 7.40 | 0.6 | 105 | 5 | 2.59 |
| 9 | 4.47 | 0.1 | 60 | 90 | 3.39 |
| 10 | 7.73 | 0.1 | 60 | 90 | 3.21 |
| 11 | 4.51 | 0.6 | 60 | 90 | 2.49 |
| 12 | 6.20 | 0.6 | 60 | 90 | 2.47 |
| 13 | 4.70 | 0.1 | 105 | 90 | 3.12 |
| 14 | 7.93 | 0.1 | 105 | 90 | 3.18 |
| 15 | 4.60 | 0.6 | 105 | 90 | 2.01 |
| 16 | 7.41 | 0.6 | 105 | 90 | 2.24 |
| 17 | 5.36 | 0.35 | 82.5 | 47.5 | 2.39 |
| 18 | 6 | 0.35 | 82.5 | 47.5 | 2.61 |
| 19 | 5.51 | 0.35 | 82.5 | 47.5 | 2.42 |

As illustrated in FIG. 9, out of the four factors studied, the Al concentration was found to have the greatest effect on reducing the air entrainment. The reaction temperature (Trxn) was found to have little effect on its own and the reaction time (TimeRxn) was found to have a moderate effect. However, it is noted that both the reaction temperature and reaction time have some synergy in reducing the % air. The effect of increasing reaction time is summarized in Table 4 below (extracted from the test data), which identifies the Al % needed to provide a desired air content:

TABLE 4

| | TimeRxn | Trxn | | |
|---|---|---|---|---|
| % Air | (min.) | (° C.) | pHrxn | % Al |
| 2.95 | 5 | 80 | 6 | 0.33 |
| 2.95 | 90 | 80 | 6 | 0.21 |

As will be understood, in order to reduce operational costs, it is advantageous to reduce the reaction time and reaction temperature. However, as indicated above, the lignosulfonate liquor itself is hot (usually about 100° C.) upon production. Therefore, since the treatment temperature can be high without expending additional cost (i.e. no additional heating is required), any minimal reaction time can be used while still achieving the desired benefits of the invention.

At pH 4, the Al treatment was found to be more efficient with a short reaction time than with a longer reaction time. However, at 90 minutes of treatment, the pH seems to have little effect on increasing the efficiency of the LS treatment. This effect is indicated in the summary table 5 below:

TABLE 5

| | TimeRxn | Trxn | | |
|---|---|---|---|---|
| % Air | (min.) | (° C.) | pHrxn | % Al |
| 2.95 | 5 | 80 | 4 | 0.28 |
| 2.95 | 5 | 80 | 6 | 0.35 |
| 2.95 | 45 | 80 | 4 | 0.24 |

### Example 11

### Use of Different Sources for Al

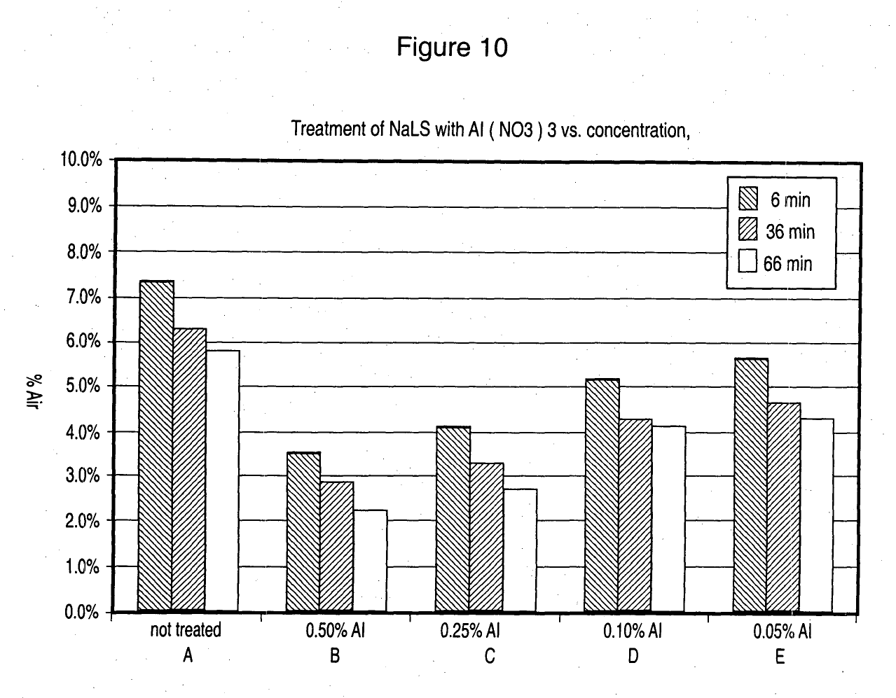

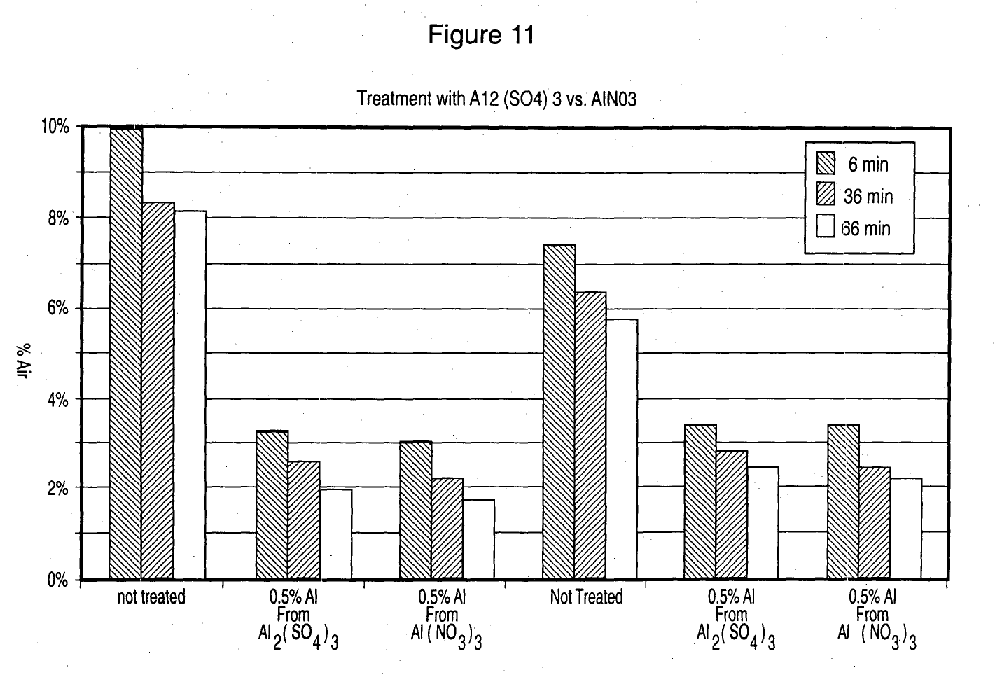

The above examples illustrated the use of aluminum sulphate (Al₂(SO₄)₃) as the source of Al for the lignosulfonate (LS) treatment. FIGS. 10 and 11 illustrate the effectiveness of the treatment process of the present invention when the Al source is Al(NO₃)₃. Anions other than sulphate or nitrate for example Cl, may be used.

In FIG. 10, trials were run with varying Al concentrations. The treatment reactions involved: 1) an initial pH adjustment to 4; 2) heating to 80° C. for 20 minutes; 3) slow adjustment of pH to 6; and 4) further heating for 20+minutes. The total heating time was approximately 1 hour. The Al concentrations were varied between 0.05%, 0.1%, 0.25% and 0.5%.

FIG. 11 compares the reduction in air entrainment when the Al source for the LS treatment is supplied in the form of Al(NO₃)₃ or Al₂(SO₄)₃. The treatment conditions were the same as those described above with respect to FIG. 10. Two trials are shown in FIG. 11 where the Al concentrations were 0.5%. The pH is lowered to the desired level using any acceptable acid such as H₂SO₄. For increasing the pH, Ca(OH)₂ was used for the sulphate and NaOH was used for the nitrate.

These results indicate that there is no significant difference between the effects of Al(NO₃)₃ and Al₂(SO₄)₃ in treating LS according to the present invention.

### Example 12

### Lignosulfonate Treatment with Fe

This example describes the results obtained from treatment of a lignosulfonate (LS) sample using iron sulphates in various conditions. Two iron sulphates were used, Fe II and Fe III in the form of FeSO₄.7H₂O and Fe₂(SO₄)₃.5H₂O, respectively. Solutions of the two sulphates were prepared in water at pH 1.5-2 at 5% iron content. The LS sample was heated to 80° C., and then the iron was added at either 0.25% or 0.5% by weight of dry lignosulfonate. The pH was adjusted to 2, 4 or 6 and then the sample was heated and stirred at 80° C. for 1 h30 m (i.e. 90 min).

It is to be noted that the molar concentration of iron is approximately half that of the aluminium samples at the same weight content (Fe: 55.847 g/mol, Al: 26.982 g/mol).

These 16 samples were tested for air entrainment. Air entrainment tests were made in 0.4 water/cement ratio cement pastes using 0.4% lignosulfonate (dry weight by weight of cement) using the samples as is, i.e., no pH adjustment.

The air entrainment measurements demonstrate a reduction in air for all of the samples with, generally, an improved performance at pH 6. No significant difference is observed between 0.25% and 0.5% or between Fe II and Fe III. The latter may be caused by oxidation of Fe II to Fe III; the 5% Fe II solution, upon standing in a transparent flask, changed colour from green to reddish brown over a period of a few weeks, the same colour as the Fe III solution.

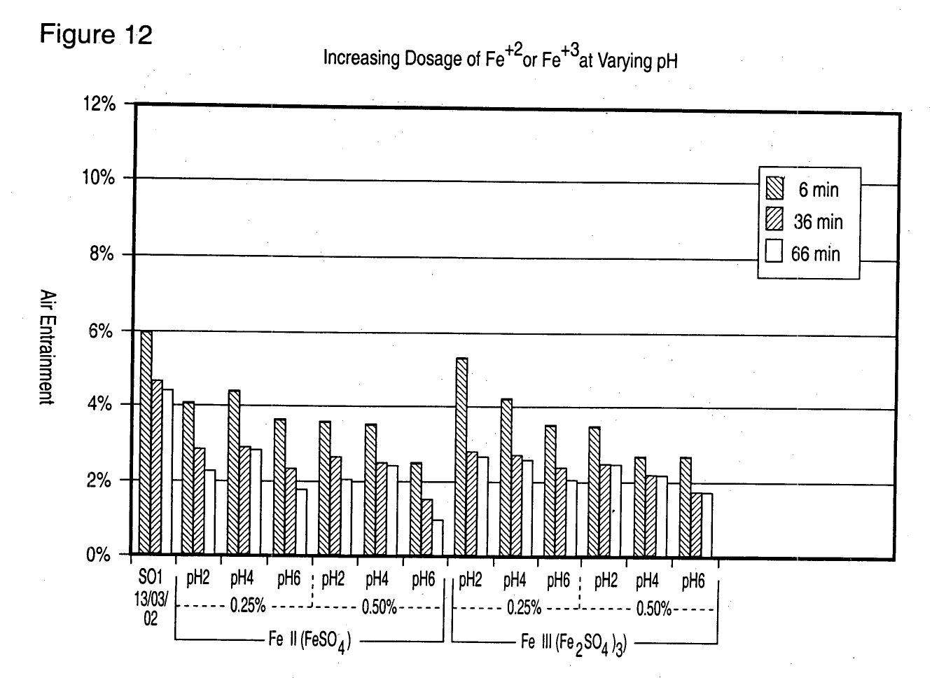

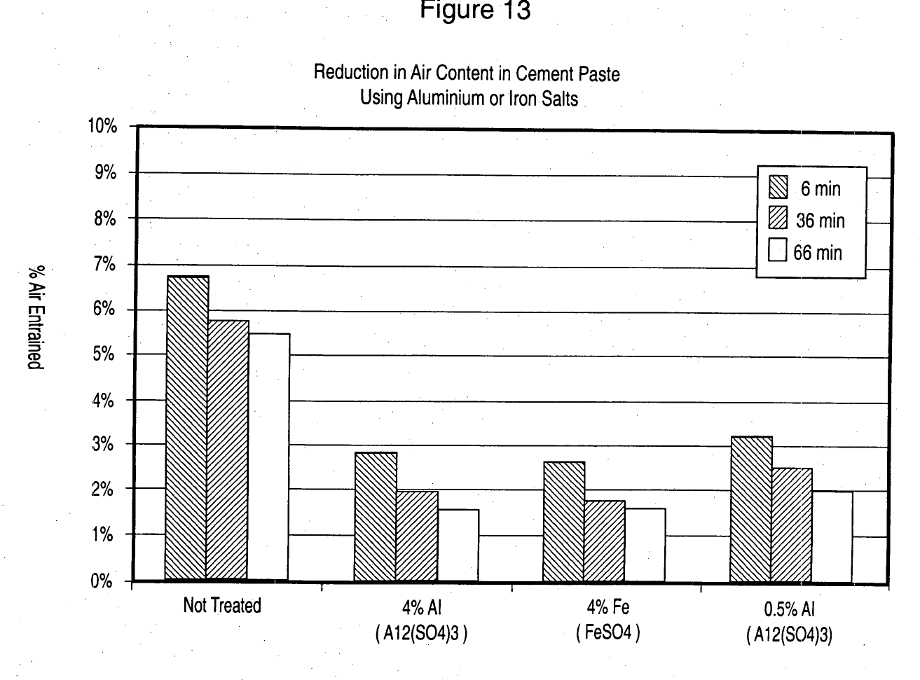

FIG. 12 illustrates the results of the air entrainment values of this example.

### Example 13

### Comparison of Al vs. Fe Treatment

In this example, comparative tests were conducted using lignosulfonates (LS) treated with 4% Al and Fe and 0.5% Al to examine their effect on air entrainment. FIG. 13 illustrates the results of these tests.

The tests of this example were made with 4% Al at pH 3.5 heated at 80° C. for 2 hours then adjusted to pH 7 and heated for a further hour. At 0.5% Al, pH was adjusted to 4 and heated for 20 minutes, then adjusted to 6 and heated a further 20 minutes.

FIG. 13 illustrates that similar reductions in air content in cement systems are achieved using either Aluminum or Iron salts to treat lignosulfonates.

### Example 14

### Air Entrainment Tests with Varying Treatment Conditions

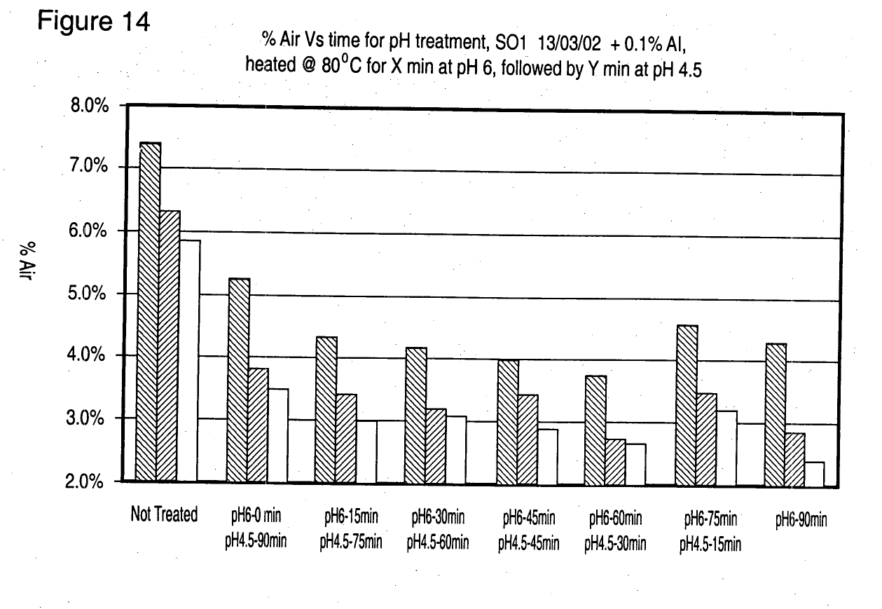

In this example, lignosulfonate samples were treated with 0.1% Al (from sulphate) at 80° C. for a total of 90 minutes. The heating step was conducted in two phases each at different times and pH values. The first phase involved a pH of 6 and the second phase, a pH of 4.5. However, two tests were conducted in a single phase at each of the pH values. The results of these tests are provided in FIG. 14.

As observed, the % air decreased with an increase in the duration of heating at pH 6. The last sample, where a single heating phase at pH 6 was used, resulted in the least air entrainment.

### Example 15

### Air Entrainment with Varying Al % and pH Chance from 6 to 4.5

In this test, the effect of treatment with different. Al dosages was investigated. In the test, Al (from Al(NO₃)₃) was added at different concentrations (w/w) to the lignosulfonate solution and heated to 80° C. for 20 minutes at pH 6 and, subsequently, another 20 minutes at pH 4.5.

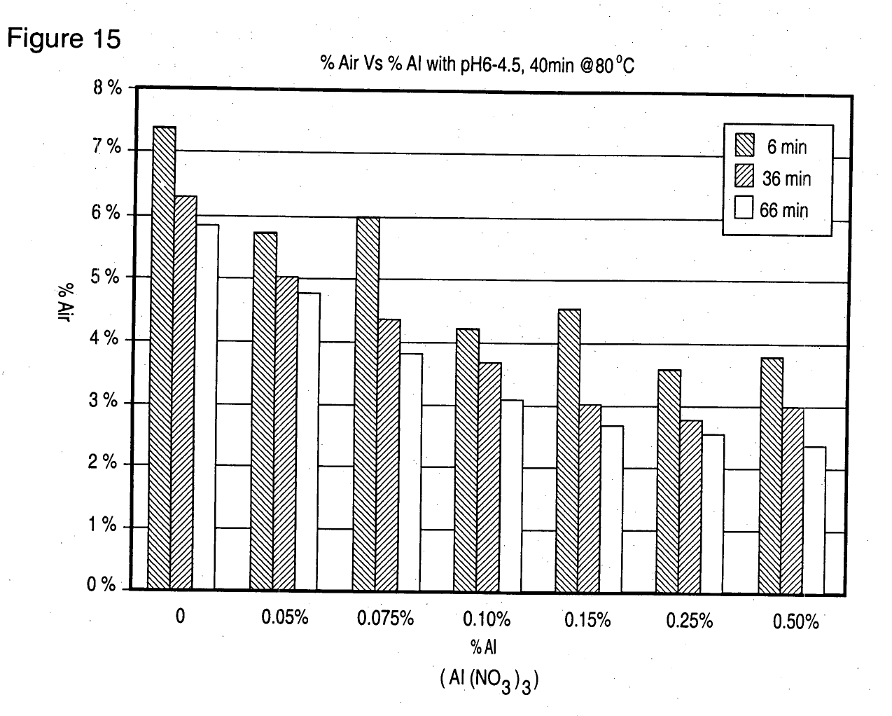

The results from this test are illustrated in FIG. 15. As shown, the air entrainment (% air) drops with increasing Al %. However, there is only a little change beyond an Al % of 0.15%.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A process for treating lignosulfonates to provide dispersants for cementitious compositions comprising:
providing a lignosulfonate solution; and,
treating said solution with divalent or trivalent metal salts.

2. The process of claim 1 wherein said metal salts comprise salts of aluminum, iron, copper or manganese.

3. The process of claim 2 wherein said salts comprise nitrates or sulphates of said metals.

4. The process of claim 3 wherein said aluminum salts are chosen from the group consisting of Al₂(SO₄)₃, Al(NO₃)₃ and combinations thereof.

5. The process of claim 3 wherein said iron salts are chosen from the group consisting of FeSO₄, Fe₂(SO₄)₃, hydrates thereof, and combinations thereof.

6. The process of claim 1 wherein said metal salts are provided in an amount between 0.05% and 4% based on the dry weight of said lignosulfonate.

7. The process of claim 6 wherein said salts are provided in an amount between 0.1% and 1%.

8. The process of claim 7 wherein said salts are provided in an amount of about 0.25%.

9. The process of claim 1 wherein said lignosulfonate solution is treated with said metal salts at a temperature of between 4° C. and 125° C.

10. The process of claim 9 wherein said temperature is between 80° C. and 105° C.

11. The process of claim 1 wherein said lignosulfonate solution is treated with said metal salts at a pH of between 3.5 and 8.

12. The process of claim 11 wherein said pH is about 6.

13. A process for preparing a lignosulfonate additive for cement or concrete fluidization, the process comprising:
providing a lignosulfonate solution;
treating said lignosulfonate solution with aluminum or iron salts in an amount between 0.05% and 4% aluminum or iron based on the dry weight of the lignosulfonate;
wherein said treatment is conducted at a temperature between 4° C. and 125° C. and at a pH between 3.5 and 8.

14. The process of claim 13 wherein said salt is Al₂(SO₄)₃.

15. A fluidizing additive for cement or concrete comprising a lignosulfonate solution produced by a process as claimed in claim 1.

16. A fluidizing additive for cement or concrete comprising a lignosulfonate solution produced by a process as claimed in claim 12.

17. An additive for fluidizing and reducing air entrainment of cement or concrete mixtures comprising a lignosulfonate solution treated with salts of trivalent metals.

18. The additive of claim 17 wherein said trivalent metals are chosen from the group comprising aluminum, iron, copper, manganese and combinations thereof.

19. The additive of claim 18 wherein said salts comprise nitrates or sulphates of said metals.
